(19) United States
(12) Patent Application Publication
(10) Pub. No.: US 2009/0014566 A1
(43) Pub. Date: Jan. 15, 2009

(54) PAPER SHREDDING TOOL

(76) Inventors: King Biu MAK, Hong Kong (CN); Chung Ming MAK, Hong Kong (CN); Ronald Chung Yin MAK, Hong Kong (CN)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/776,344

(22) Filed: Jul. 11, 2007

(51) Int. Cl. B02C 1/08

(52) U.S. Cl. 241/236

(57) ABSTRACT

A paper shredding tool is disclosed as including a first pair of cutters partly abutting each other along a first cutting plane; a second pair of cutters adjacent to the first pair of cutters, the second pair of cutters partly abutting each other along a second cutting plane; a third pair of cutters partly abutting each other along a third cutting plane; and a fourth pair of cutters adjacent to the third pair of cutters, the fourth pair of cutters partly abutting each other along a fourth cutting plane; in which each pair of cutters are rotatable relative to each other to cut a piece of paper passing between the pair of cutters along their respective cutting plane; and the distance between the first cutting plane and the second cutting plane is different from the distance between the third cutting plane and the fourth cutting plane.

This invention relates to a paper shredding tool and, in particular, such a tool adapted to be installed in a paper shredder.

### BACKGROUND OF THE INVENTION

Paper shredders are used for cutting pieces of paper into strips and/or pieces, for security reasons. As shown in FIGS. 1A to 1C, in a first conventional paper shredding tool generally designated as 10, two parallel spindles 12, 14 are provided, to each of which a number of circular cutting blades 16, 18 are engaged for simultaneous rotational movement in opposite directions. As shown in FIG. 1C, and using the spindle 12 as an example, the spindle 12 is formed with a longitudinal trough 20 for engagement with a correspondingly sized, shaped and configured protrusion 22 in a hole 24 of the cutting blade 16. The spindle 12 may thus be received through the hole 24 of the cutting blade 16 for simultaneous rotation about the spindle 12. The cutting blade 16 is fixedly engaged with the spindle 12, e.g. by welding.

Pairs of cutting blades 16, 18 are positioned in such a way that their major surfaces partly abut each other to form a number of parallel cutting planes at which, when in operation, cutting action occurs. In operation, a motor (not shown) is operated to drive a transmission mechanism (not shown) for bringing the spindle 12 into rotational movement in the direction indicated by the arrow A in FIG. 1A and bringing the spindle 14 into rotational movement in the opposite direction, i.e. as indicated by the arrow B in FIG. 1A. A piece of paper passing between the two spindles 12, 14 will be cut by the pairs of cutting blades 16, 18 into long strips of paper. This type of cutting is therefore called “strip cut”. Rotation of the cutting blades 16, 18 also draws the paper through the space between the spindles 12, 14, thus acting as a paper feeding mechanism.

In this conventional paper shredding tool 10, the distance between the cutting planes of adjacent pairs of cutting blades 16, 18 is the same, namely W₁, e.g. 4 mm. The strips of paper cut out by such a shredding tool 10 are thus of the same width, irrespective of the level of security required or the degree of confidentiality of the information contained in the piece of paper.

A second conventional paper shredding tool is shown in FIGS. 2A and 2B, and generally designated as 50. The shredding tool 50 has two parallel spindles 52, 54 to each of which a number of cutters 56, 58 are engaged for simultaneous rotational movement about the respective spindle 52, 54 in opposite directions. It can be seen that each of the cutter 56, 58 is made of a pair of cutting discs 56a, 56b, 58a, 58b, each having a number of cutting elements 60 protruding from their respective circumferences.

As shown in FIG. 2C, and using the spindle 52 as an example, the spindle 52 is formed with a longitudinal trough 62 for engagement with a correspondingly sized, shaped and configured protrusion 64 in a hole 66 of the cutting disc 56b of the cutter 56. The spindle 52 may thus be received through the hole 66 of the cutting disc 56b of the cutter 56 for bringing the cutting disc 56b into simultaneous rotation with and about the spindle 52. The cutting disc 56b of the cutter 56 is fixedly engaged with the spindle 52, e.g. by welding.

Pairs of cutters 56, 58 are positioned in such a way that their major surfaces partly abut each other to form a number of parallel cutting planes at which, when in operation, cutting action occurs. In addition, the tips of each pair of the cutting discs 56a, 56b of the cutters 56 and the tips of each pair of the cutting discs 58a, 58b of the cutters 58 are in touch with each other, as show in FIGS. 2A and 2B. In operation, a motor (not shown) is operated to drive a transmission mechanism (not shown) for bringing the spindle 52 into rotational movement in the direction indicated by the arrow C in FIG. 2A and bringing the spindle 54 into rotational movement in the opposite direction, i.e. as indicated by the arrow D in FIG. 2A. A piece of paper passing between the two spindles 52, 54 will be cut by the pairs of cutters 56, 58 into long strips of paper, and further cut by the protruding cutting elements 60 of the cutters 56, 58 into short pieces. This type of cutting is called “cross cut” because, in addition to cutting the paper along the direction of movement of the paper relative to the shredding tool 50, the shredding tool 50 also cuts the paper in a direction perpendicular to this direction of movement. Rotation of the cutters 56, 58 also draws the paper through the space between the spindles 52, 54, thus acting as a paper feeding mechanism.

In this conventional paper shredding tool 50, the distance between the cutting planes of 30 adjacent pairs of cutters 56, 58 is the same, namely W₂, e.g. 3 mm. The pieces of paper cut out by such a shredding tool 50 are thus of the same width, irrespective of the level of security required or the degree of confidentiality of the information contained in the piece of paper.

Theoretically speaking, the highest security level is achieved by cutting the paper into the narrowest possible strips and shortest possible pieces, so as to reduce as much as possible legibility of the contents of the shredded paper strips or pieces, and to make re-assembling of the cut paper strips and pieces to their original positions as difficult as possible.

To achieve this high security level, hundreds of cutting blades have to be manufactured and installed in the paper shredder, resulting in consumption of a large amount of electricity, as high torque is required for cutting pieces of paper into such short and narrow strips and pieces. High torque motors and strong frames are also required. The consequential cost is thus very high.

However, it is found in practice that for most letters, correspondence, forms, bills, or the like documents, only information within one or more longitudinal bands of the documents is confidential, or the degree of confidentiality differs among various types of information.

Take a purchase order as an example, the unit price of the goods (which may be near the right-hand margin of the document) may be the most confidential piece of information, the quantity of goods sold (which may be shown somewhat towards the middle portion of the document) may be slightly less confidential, and the material with which the goods is made may be still less confidential.

In addition, for a document containing confidential information, e.g. a password or pass code, it is not necessary to have the whole password or pass code shredded to very short and narrow pieces. It is enough for practical purposes for part of the password or pass code to be shredded to very short and narrow pieces.

It is thus an object of the present invention to provide a paper shredding tool and a paper shredder with such a tool in which different portions of the paper are cut into strips or pieces of different widths, e.g. to cater for different confidentiality levels, or at least to provide a useful alternative to the trade and public.

### SUMMARY OF THE INVENTION

According to a first aspect of the present invention, there is provided a paper shredding tool including a first pair of cutting members partly abutting each other along a first cutting plane; a second pair of cutting members adjacent to said first pair of cutting members, said second pair of cutting members partly abutting each other along a second cutting plane; a third pair of cutting members partly abutting each other along a third cutting plane; and a fourth pair of cutting members adjacent to said third pair of cutting members, said fourth pair of cutting members partly abutting each other along a fourth cutting plane; wherein each pair of cutting members are rotatable relative to each other to cut a piece of paper passing between said pair of cutting members along said respective cutting plane; and wherein the distance between said first cutting plane and said second cutting plane is different from the distance between said third cutting plane and said fourth cutting plane.

According to a second aspect of the present invention, there is provided a paper shredder including a first pair of cutting members partly abutting each other along a first cutting plane; a second pair of cutting members adjacent to said first pair of cutting members, said second pair of cutting members partly abutting each other along a second cutting plane; a third pair of cutting members partly abutting each other along a third cutting plane; and a fourth pair of cutting members adjacent to said third pair of cutting members, said fourth pair of cutting members partly abutting each other along a fourth cutting plane; wherein each pair of cutting members are rotatable relative to each other to cut a piece of paper passing between said pair of cutting members along said respective cutting plane; and wherein the distance between said first cutting plane and said second cutting plane is different from the distance between said third cutting plane and said fourth cutting plane.

### BRIEF DESCRIPTION OF THE DRAWINGS

Preferred embodiments of the present invention will now be described, by way of example only, with reference to the accompanying drawings, in which:

FIG. 1A is a top perspective view of a first prior art paper shredding tool;

FIG. 1B is a top view of the paper shredding tool shown in FIG. 1A;

FIG. 1C shows the way in which a cutting blade of the paper shredding tool of FIG. 1A is engaged with a spindle;

FIG. 2A is a top perspective view of a second prior art paper shredding tool;

FIG. 2B is a top view of the paper shredding tool shown in FIG. 2A;

FIG. 2C shows the way in which a cutting blade of the paper shredding tool of FIG. 2A is engaged with a spindle;

FIG. 3 is a top view of a paper shredding tool according to a first preferred embodiment of the present invention;

FIG. 4 shows schematically a piece of paper as shredded by the paper shredding tool of FIG. 3;

FIGS. 5A to 5E show possible cutting patterns of a paper shredding tool based on that shown in FIG. 3;

FIG. 6 is a top view of a paper shredding tool according to a second preferred embodiment of the present invention;

FIG. 7 shows schematically a piece of paper as shredded by the paper shredding tool of FIG. 6;

FIGS. 8A to 8E show possible cutting patterns of a paper shredding tool based on that shown in FIG. 6;

FIG. 9 is a top view of a paper shredding tool according to a third preferred embodiment of the present invention;

FIGS. 10A to 10D show possible cutting patterns of a paper shredding tool based on that shown in FIG. 9;

FIG. 11 is a top view of a paper shredding tool according to a fourth preferred embodiment of the present invention;

FIG. 12 shows schematically a piece of paper as shredded by the paper shredding tool of FIG. 11;

FIG. 13 is a top view of a paper shredding tool according to a fifth preferred embodiment of the present invention;

FIG. 14 shows the manner of engagement of the cutting blades for simultaneous movement along two spindles of the paper shredding tool of FIG. 13;

FIG. 15 is a top view of a paper shredding tool according to a sixth preferred embodiment of the present invention;

FIG. 16 shows movement of a number of cutting blades of the paper shredding tool shown in FIG. 15;

FIG. 17 shows the manner of engagement of the cutting blades' for simultaneous movement along two spindles of the paper shredding tool of FIGS. 15 and 16;

FIGS. 18A to 18E show different cutting patterns achieved by different manner of movement of a number of pairs of cutting blades along two spindles;

FIG. 19 is a side view of a paper shredding tool according to a seventh preferred embodiment of the present invention;

FIG. 20 is a side view of a paper shredding tool according to an eighth preferred embodiment of the present invention; and

FIG. 21 is a side view of a paper shredding tool according to a ninth preferred embodiment of the present invention.

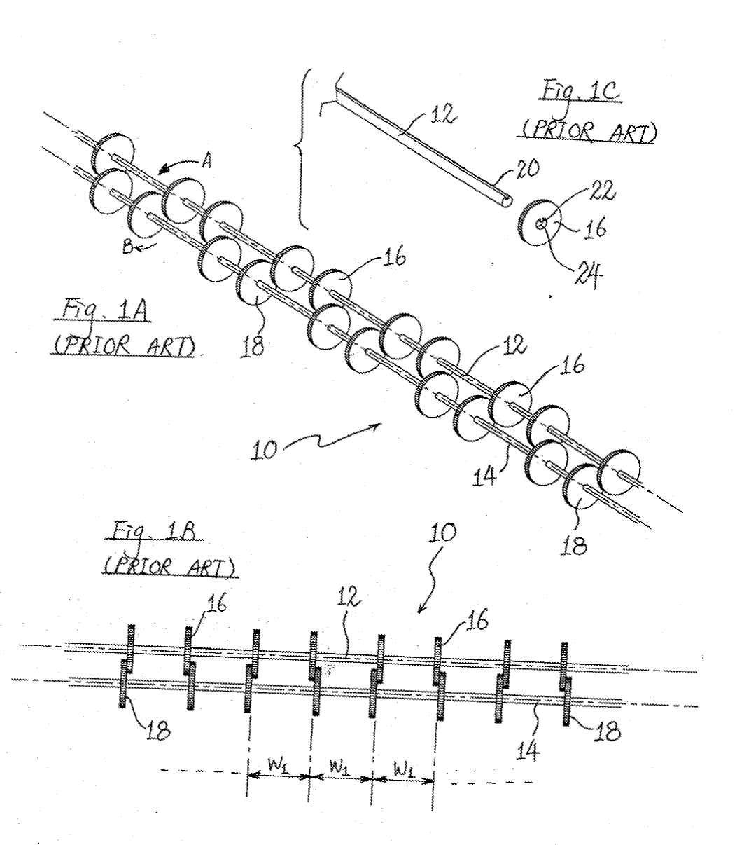

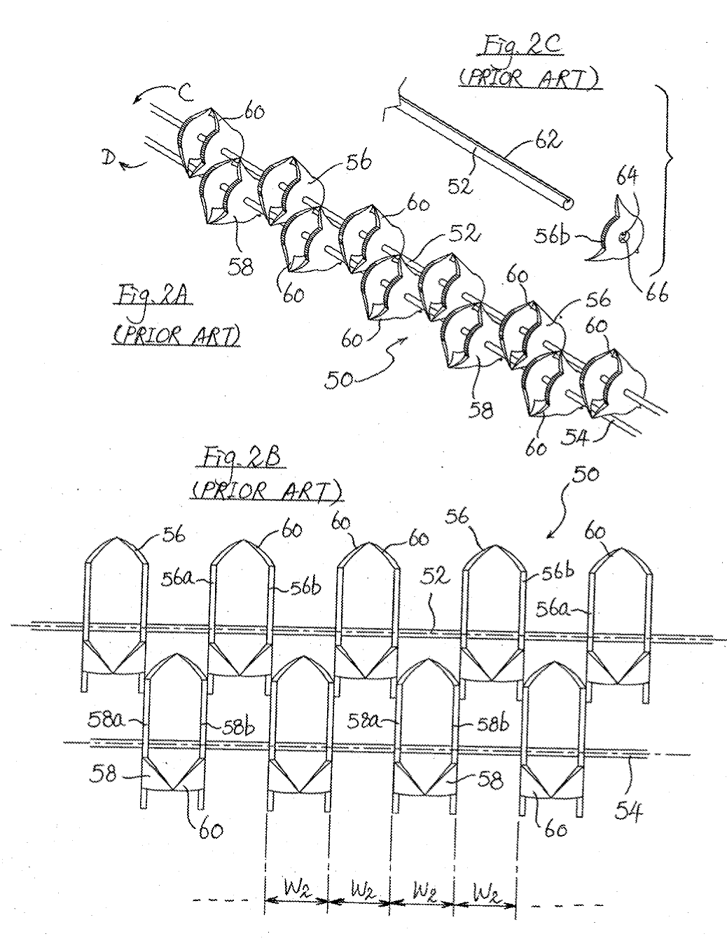

### DETAILED DESCRIPTION OF THE PREFERRED EMBODIMENTS

A top view of a paper shredding tool according to a first preferred embodiment of the present invention is shown in FIG. 3, generally designated as 100. This paper shredding tool 100 has two parallel spindles 102, 104, along each of which a number of circular rotary cutting blades 106, 108 are fixedly engaged for simultaneous rotation with and about the respective spindle 102, 104.

Pairs of cutting blades 106, 108 are positioned in such a way that their major surfaces 10 partly abut each other to form a number of parallel cutting planes. Upon activation of a motor (not shown), the spindles 102, 104 are driven to rotate, so as to cause the cutting blades 106, 108 to rotate relative to each other in opposite directions to cut pieces of paper passing between the spindles 102, 104. A major feature of this shredding tool 100 is that the cutting planes are not evenly distributed along the spindles 102, 104. As shown in FIG. 3, some of the adjacent cutting planes may be spaced from each other by a distance W₃, e.g. 1 mm, whereas some of the adjacent cutting planes may be spaced from each other by a different distance W₄, e.g. 4 mm. In particular, the cutting plane of the pair of cutting blades 106a, 108a is “spaced from the cutting plane of the pair of cutting blades 106b, 108b by W₃, the cutting plane of the pair of cutting blades 106b, 108b is spaced from the cutting plane of the pair of cutting blades 106c, 108c by W₃, the cutting plane of the pair of cutting blades 106c, 108c is spaced from the cutting plane of the pair of cutting blades 106d, 108d by W₄, and the cutting plane of the pair of cutting blades 106d, 108d is spaced from the cutting plane of the pair of cutting blades 106e, 108e by W₄.

As shown in FIG. 4, by operating a paper shredder with such a paper shredding tool 100, a piece of paper 110 may be cut into a number of narrow strips of paper, some of a width of W₃, and some of a width of W₄, which is larger than W₃. For example, the pairs of adjacent cutting blades 106, 108 spaced by a distance of W₃ may be arranged to cut a portion 112 of the paper 110 containing confidential data, whereas the pairs of adjacent cutting blades 106, 108 spaced by a distance of W₄ may be arranged to cut the remaining portion of the piece of paper containing less confidential data.

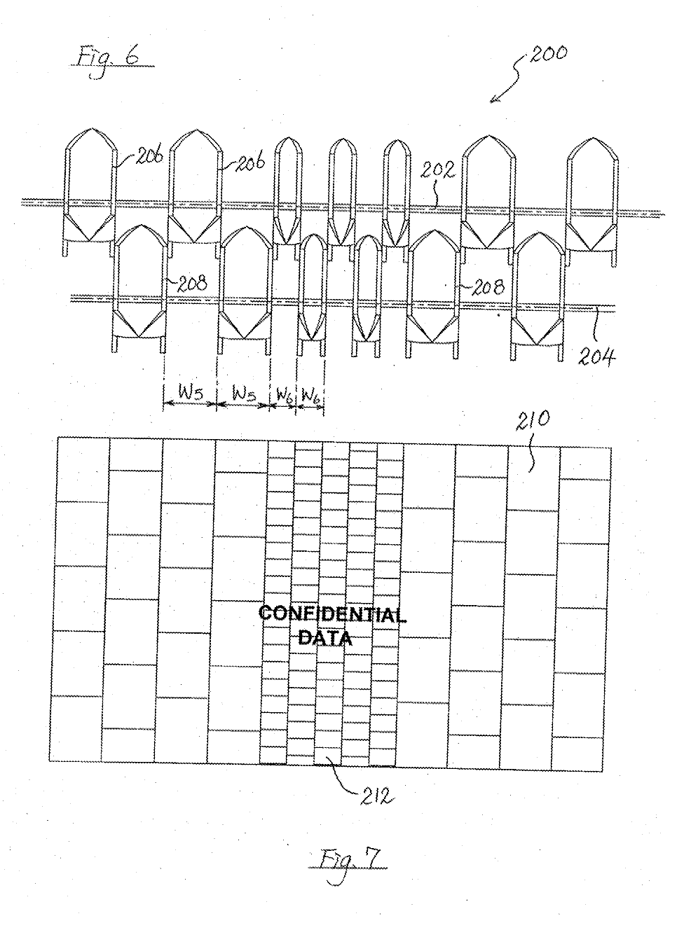

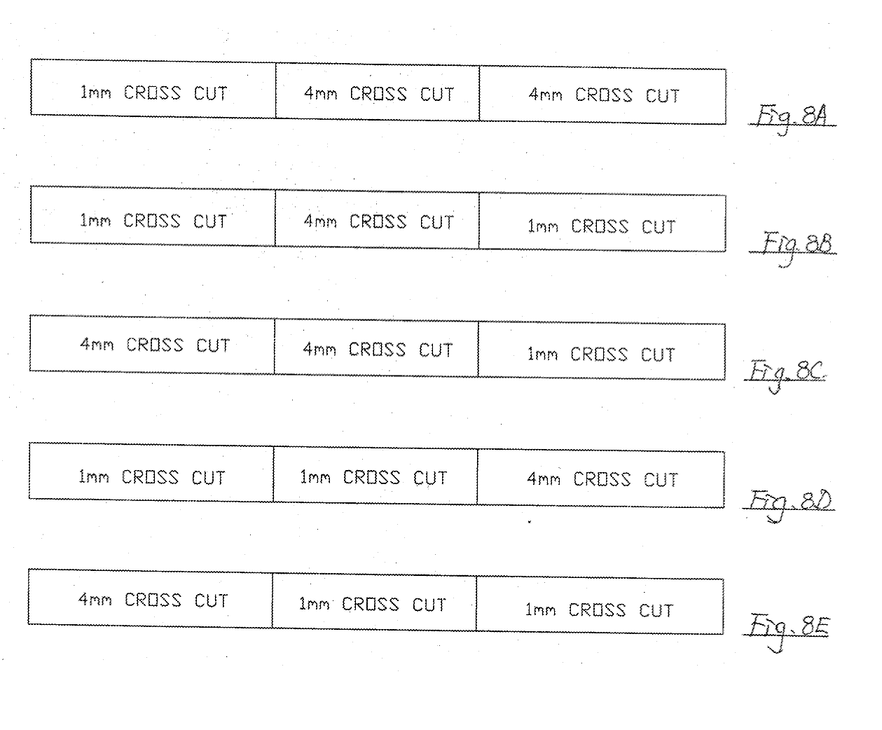

Based on this principle, it is possible to produce the shredding patterns schematically shown in FIGS. 5A to 5E by suitably arranging the distance between adjacent pairs of cutting blades 106, 108, and thus the distance between the cutting planes of adjacent pairs of cutting blades 106, 108. For example, using FIG. 5B as an example, it is possible to so arrange the distance between adjacent pairs of cutting blades 106, 108 such that the cutting planes of a number of pairs of cutting blades 106, 108 are spaced by 1 mm (thus producing a 1 mm strip cut pattern across, say, one third of the width of the paper), then followed by a number of cutting blades 106, 108 whose cutting planes are spaced by 4 mm (thus producing a 4 mm strip cut pattern across, say, the next one third of the width of the paper), and finally followed by a number of cutting blades 106, 108 whose cutting planes are spaced by 1 mm (thus producing a 1 mm strip cut pattern across, say, the final one third of the width of the paper).

A top view of a paper shredding tool according to a second preferred embodiment of the present invention is shown in FIG. 6, generally designated as 200. This paper shredding tool 200 has two parallel spindles 202, 204, along each of which a number of rotary cutters 206, 208 are fixedly engaged for simultaneous rotation with and about the respective spindle 202, 204.

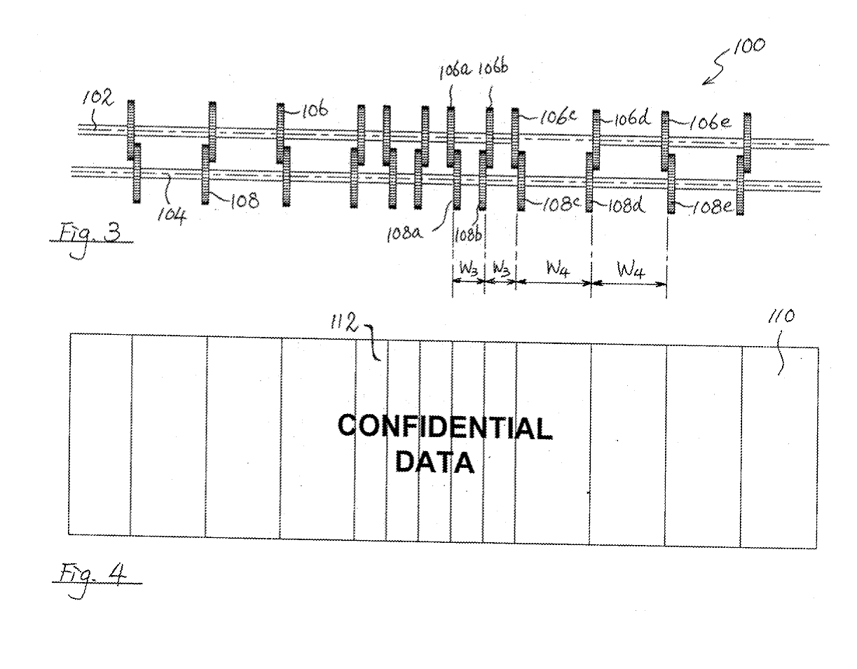

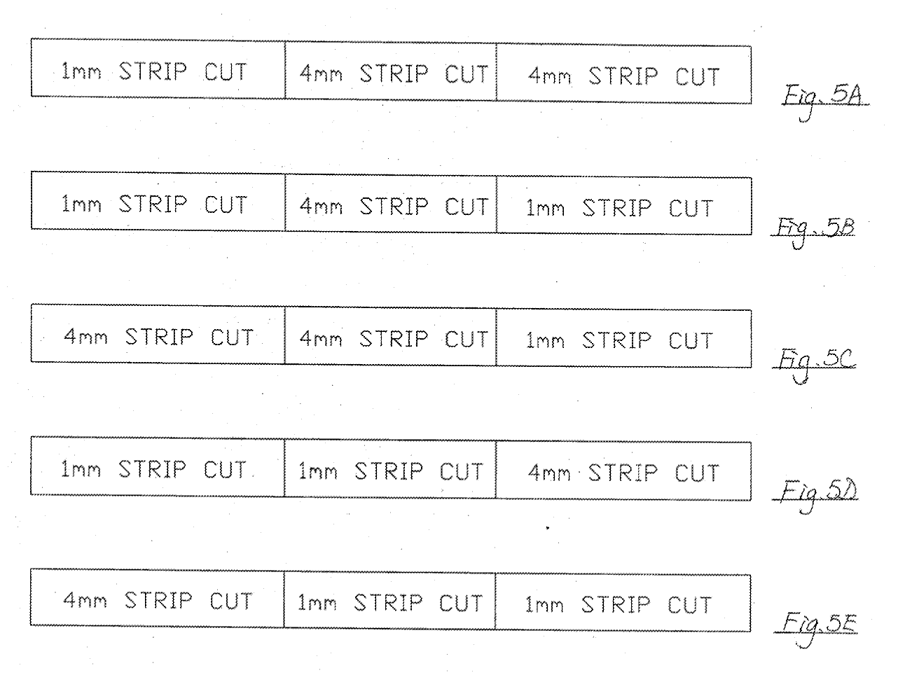

It can be seen that the structure of the paper shredding tool 200 is similar to the conventional cross cut shredding tool shown in FIGS. 2A to 2C and discussed above. One main feature of this paper shredding tool 200 is that, as in the case of the paper shredding tool 100 discussed above, the pairs of cutters 206, 208 are not evenly distributed along the parallel spindles 202, 204, so that the cutting planes of the pairs of cutters 206, 208 also are not evenly distributed. In the example shown in FIG. 6, adjacent cutting planes are spaced by W₅ or W₆, in which W₆ is narrower than W₅.

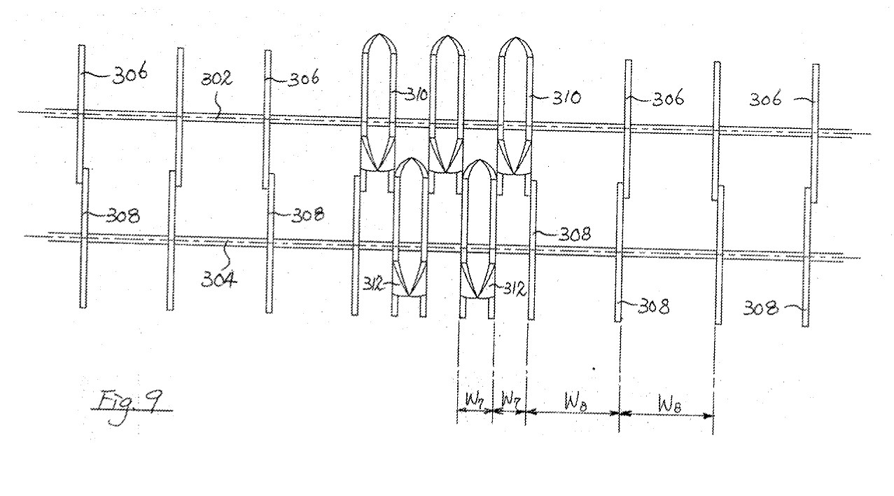

A second special feature of the paper shredding tool 200 is that the number of cutting elements protruding from the circumferences of the cutters 206, 208 also differs. For example, for cutters 206, 208 responsible for cutting out pieces of paper of a width of W₆, there may be seven or eight cutting elements protruding from their circumference, whereas for cutters 206, 208 responsible for cutting out pieces of paper of a width of W₅, there may just be three or four cutting elements protruding from their circumference. By way of such an arrangement, and as shown in FIG. 7, a portion 212 of a piece of paper 210 bearing confidential data can be cut into shorter and narrower pieces of paper than those cut out from the remaining part of the piece of paper 210.

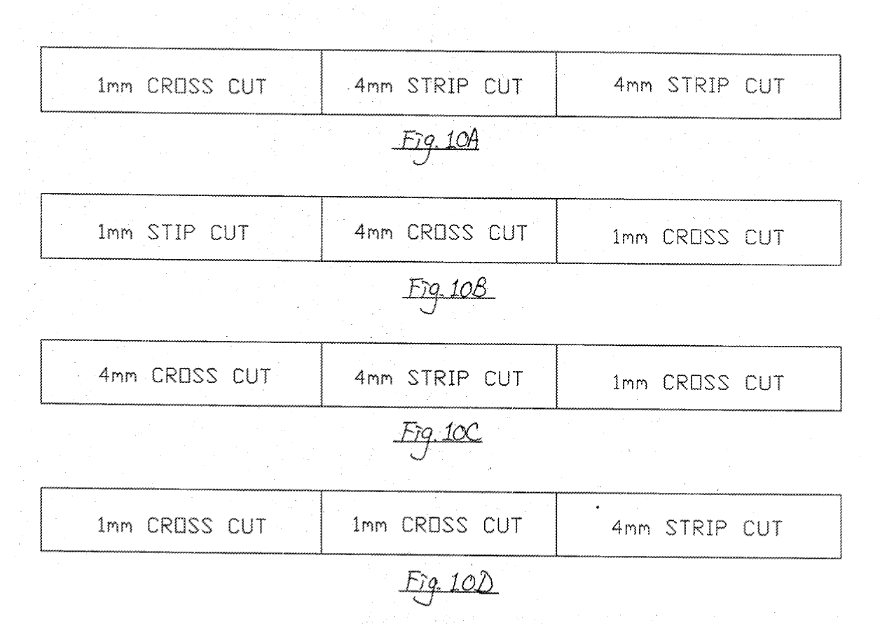

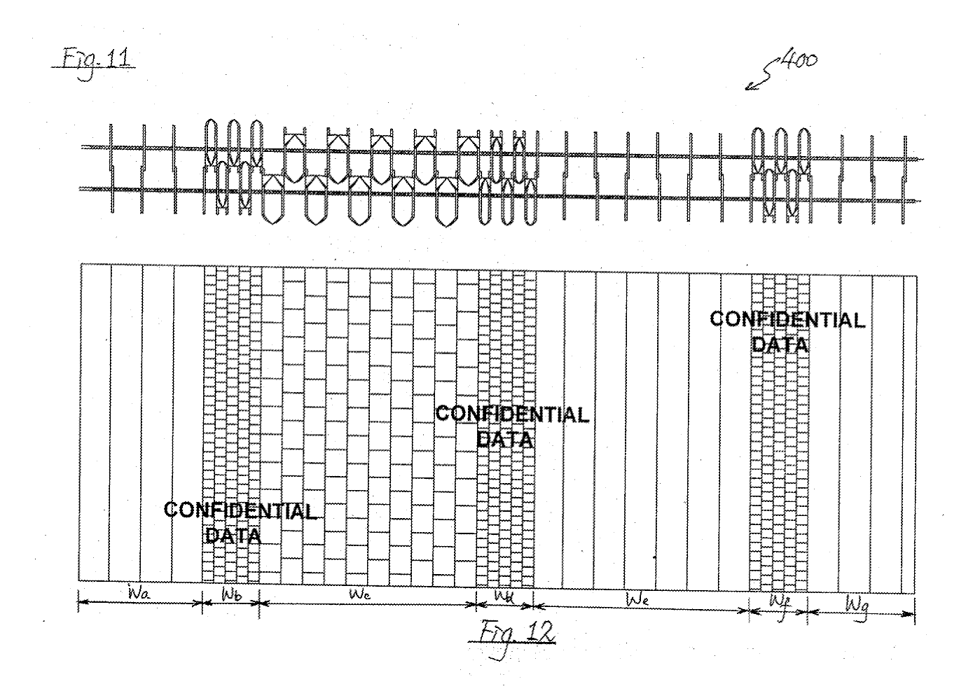

Based on this principle, it is possible to produce the shredding patterns schematically shown in FIGS. 8A to 8E by suitably arranging the distance between adjacent pairs of cutting blades 206, 208, and thus the distance between the cutting planes of adjacent pairs of cutting blades 206, 208. For example, using FIG. 8B as an example, it is possible to so arrange the distance between adjacent pairs of cutting blades 206, 208 that the cutting planes of a number of pairs of cutting blades 206, 208 are spaced by 1 mm (thus producing a 1 mm cross cut pattern across, say, one third of the width of the paper), then followed by a number of cutting blades 206, 208 whose cutting planes are spaced by 4 mm (thus producing a 4 mm cross cut pattern across, say, the next one third of the width of the paper), and finally followed by a number of cutting blades 206, 208 whose cutting planes are spaced ?y 1 mm (thus producing a 1 mm cross cut pattern across, say, the final one third of the width of the paper).

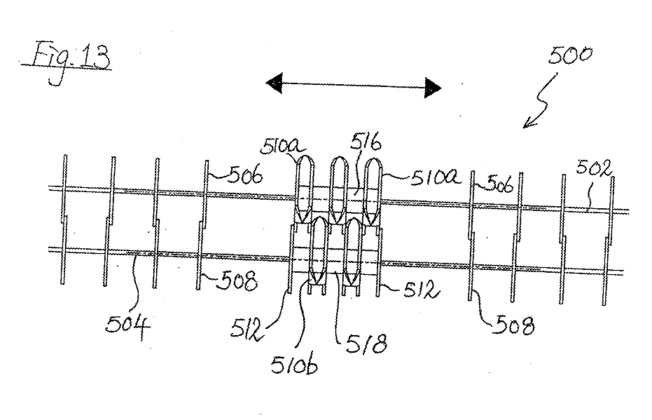

Strip cutting and cross cutting may be combined in a single paper shredding tool, e.g. as shown in FIG. 9 and generally designated as 300. This paper shredding tool 300 includes both strip cutting blades 306, 308 and cross cutting blades 310, 312. By unevenly distributing and fixing such cutting blades 306, 308, 310, 312 along a pair of parallel spindles 302, 304, e.g. with some cutting planes of adjacent pairs of cutting blades separated by a distance W₇, and some separated by a distance W₈ (which is larger than W₇), it is possible to produce results of both strip cutting patterns and cross cutting patterns of different widths, as shown in the examples of FIG. 10A to 10D.

A paper shredding tool according to a fourth preferred embodiment of the present invention is shown in FIG. 11 and generally designated as 400. It can be seen from FIG. 12 that such a paper shredding tool 400 can produce a shredding pattern with (counting from the left) a width Wₐ of strip-cut paper, a width W_{b} of narrowly cross-cut paper, a width W_{c} of broadly cross-cut paper, a width W_{d} of narrowly cross-cut paper, a width Wₑ of strip-cut paper, a width W_{f} of narrowly cross-cut paper, and a width W_{g} of strip-cut paper. The pattern may be designed so that portion of the piece of paper bearing confidential data is narrowly cross-cut.

A paper shredding tool according to a fifth preferred embodiment of the present invention is shown in FIG. 13, and generally designated as 500. In this paper shredding tool 500, strip cutting blades 506, 508 are fixedly engaged with spindles 502, 504 for simultaneous movement with the respective spindle 502, 504. On the other hand, cross cutting blades 510a, 510b, 512 are only engaged with the spindles 502, 504 for simultaneous rotational movement, but is otherwise movable along the spindles 502, 504 to and fro relative to the cutting blades 506, 508.

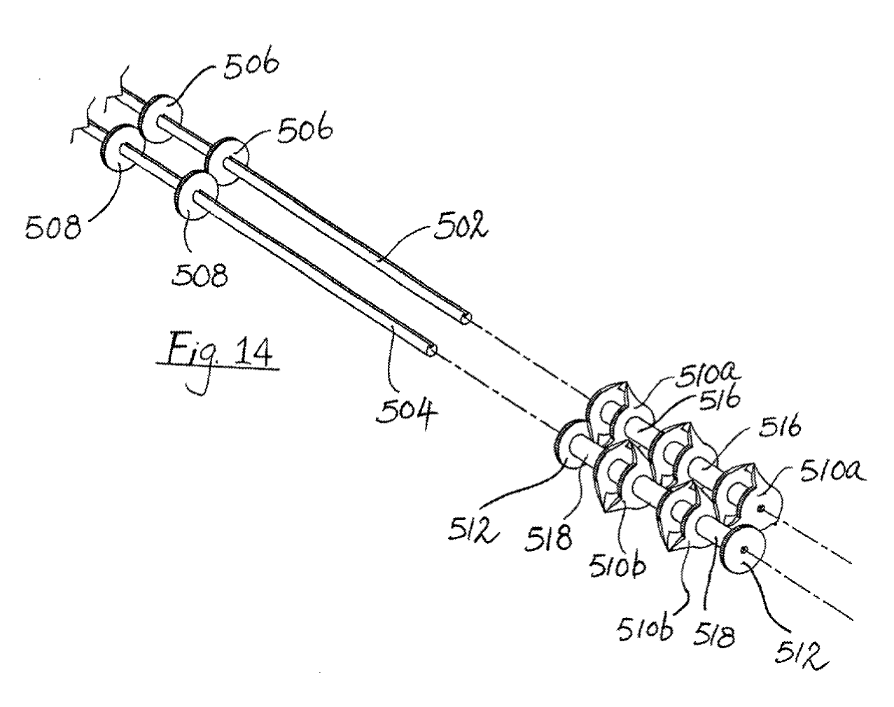

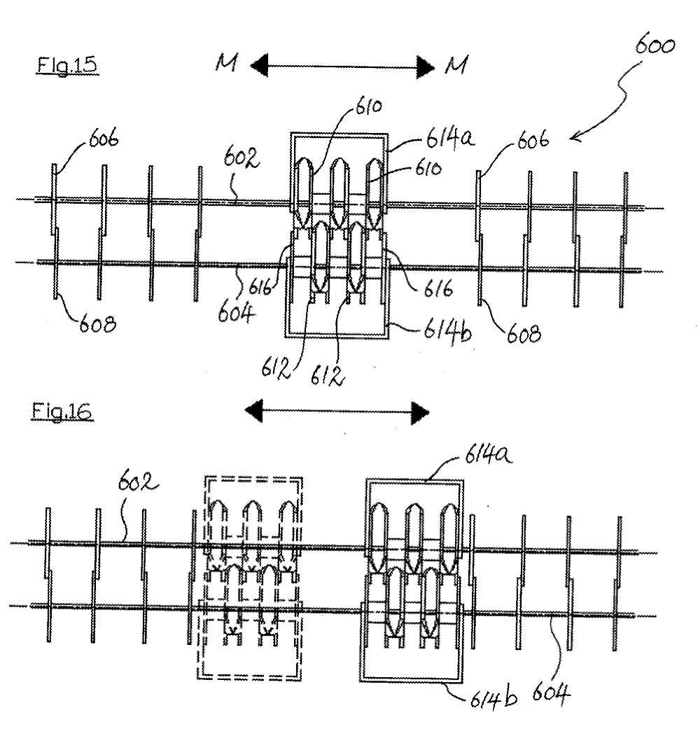

In particular, as shown in FIG. 14, the cross cutting blades 510a are fixedly engaged with a number of axles 516, e.g. by welding, for simultaneous movement along the spindle 502, and for simultaneous rotational movement about the spindle 502. Similarly, the strip cutting blades 512 and cross cutting blades 510b are fixedly engaged, e.g. by welding, with a number of axles 518 for simultaneous movement along the spindle 504, and for simultaneous rotational movement about the spindle 504. Because of the engagement between the cross cutting blades 510a and the strip cutting blades 512 and cross cutting blades 510b, movement of the cross cutting blades 510a along the spindle 502 will bring about corresponding movement of the cross cutting blades 510a and the strip cutting blades 512 along the spindle 504.

A paper shredding tool according to a sixth preferred embodiment of the present invention is shown in FIGS. 15 and 16, and generally designated as 600. This paper shredding tool 600 is similar to the tool 500 discussed above, with the major difference being that a number of cross cutting blades 610 are engaged with a frame 614a for simultaneous linear reciprocating movement along a spindle 602 relative to the remaining cutting blades 606 in the direction of the bi-directional arrow M-M. Similarly, cross cutting blades 612 and strip cutting blades 616 are engaged with a frame 614b for simultaneous linear reciprocating movement along a spindle 604 relative to the remaining cutting blades 608 in the direction of the bi-directional arrow M-M. The frames 614a, 614b are also engaged with each other for simultaneous linear reciprocating movement between the position shown in solid line and that shown in dotted line, as shown in FIG. 15.

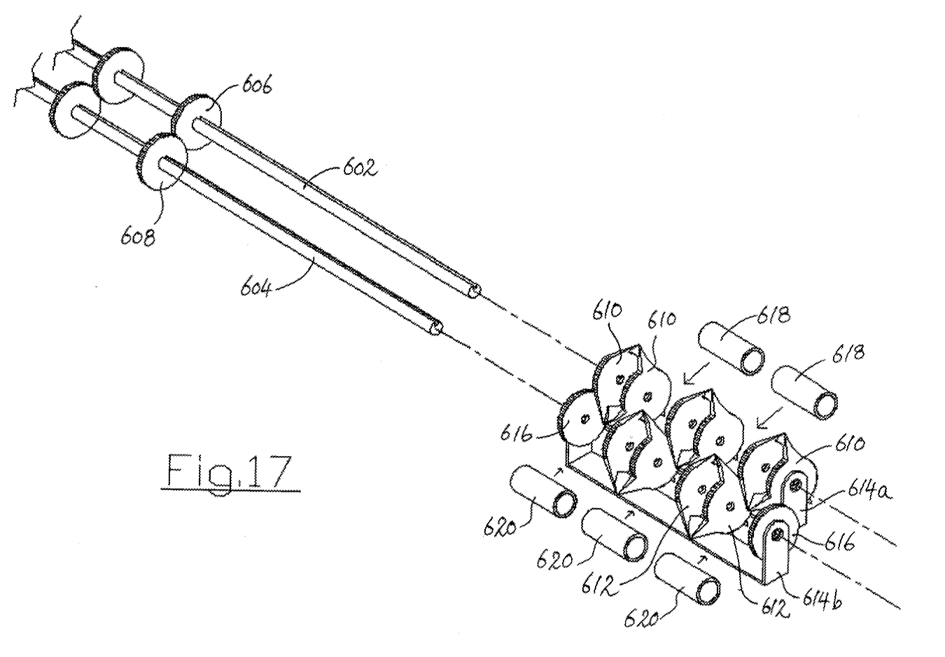

As shown in FIGS. 16 and 17, pairs of cross cutting blades 610 carried by the spindle 602 are separated from one another by cylindrical tubes 618, and are carried by the frame 614a for simultaneous movement along the length of the spindle 602. The cylindrical tubes 618 may be fixedly engaged with the adjacent cross cutting blades 610 for simultaneous rotational and linear movement, or be loosely carried by the spindle 602. Similarly, pairs of cross cutting blades 612 carried by the spindle 604 are separated from one another and from the strip cutting blades 616 by cylindrical tubes 620, and are carried by the frame 614b for simultaneous movement along the length of the spindle 604. The tubes 620 may be fixedly engaged with the adjacent cross cutting blades 612 and strip cutting blades 616 for simultaneous rotational and linear movement, or be loosely carried by the spindle 604.

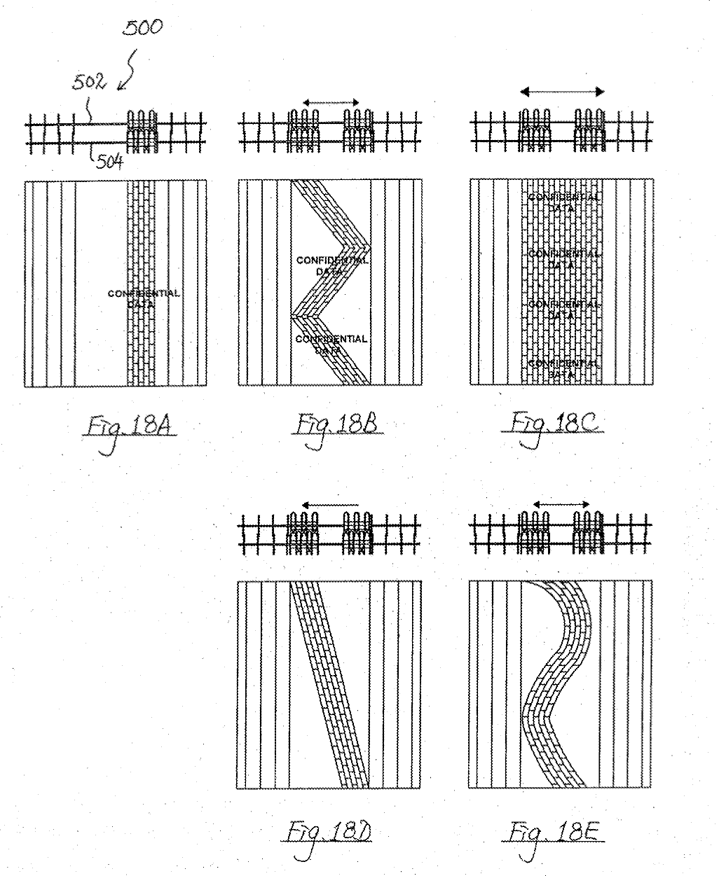

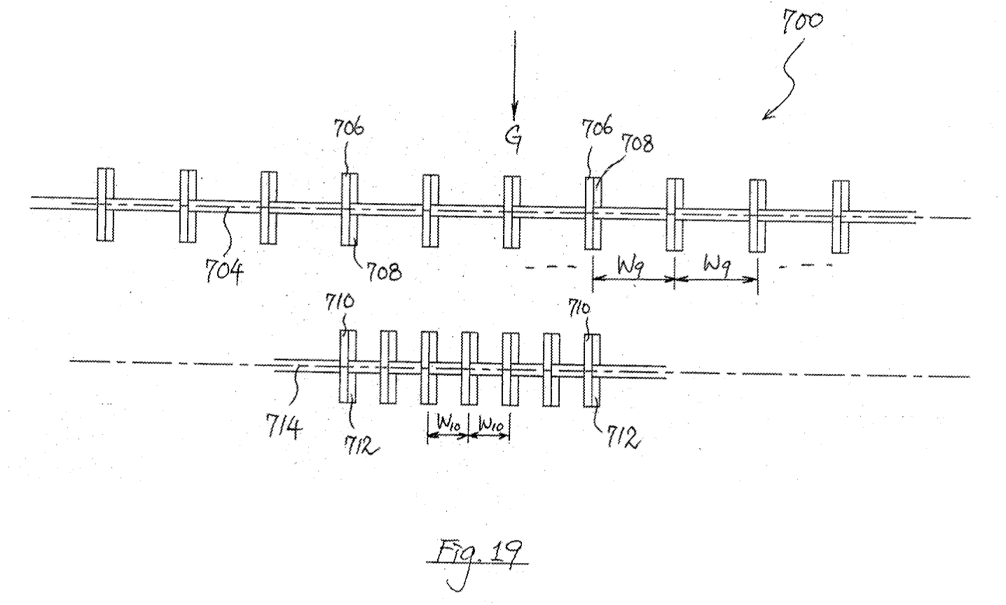

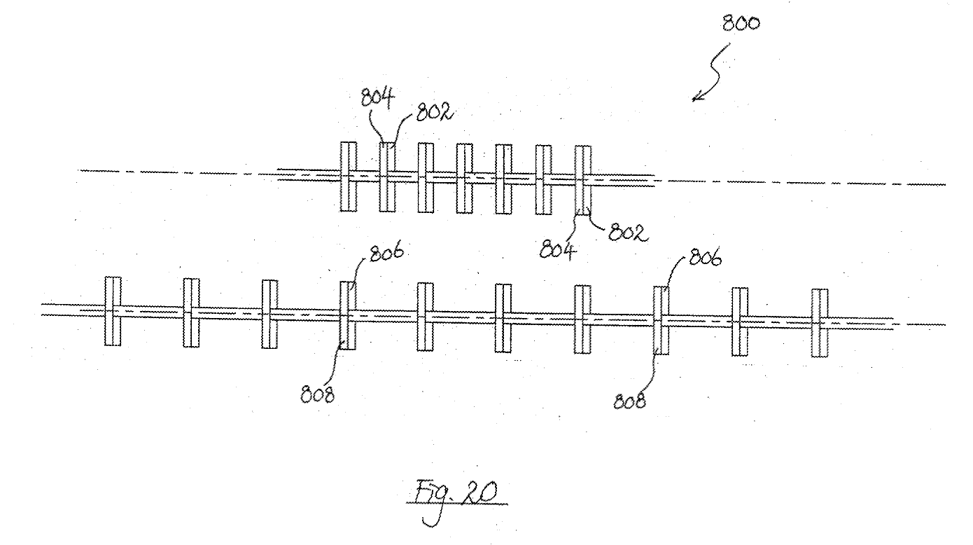

Depending on the speed at which the cross cutting blades 510, 512 of the paper shredding tool 500 move along the spindles 502, 504 relative to the remaining cutting blades 506, 508, different cutting patterns may emerge. The cutting pattern shown in FIG. 18A is produced by the paper shredding tool 500 in which the cross cutting blades 510, 512 do not move to and fro along the spindles 502, 504. The cutting pattern shown in FIG. 18B is produced by the paper shredding tool 500 in which the cross cutting blades 510, 512 move to and fro along the spindles 502, 504 at a relatively low constant speed. The cutting pattern shown in FIG. 18C is produced by the paper shredding tool 500 in which the cross cutting blades 510, 512 move to and fro along the spindles 502, 504 at a relatively high constant speed. The cutting pattern shown in FIG. 18D is produced by the paper shredding tool 500 in which the cross cutting blades 510, 512 move along the spindles 502, 504 from one side to another at a very low constant speed. The cutting pattern shown in FIG. 18E is produced by the paper shredding tool 500 in which the cross cutting blades 510, 512 move to and fro along the spindles 502, 504 at a speed that varies, e.g. sinusoidally. The same cutting patterns may also be produced by appropriately operating the paper shredding tool 600.

A paper shredding tool according to a seventh preferred embodiment of the present invention is shown in FIG. 19, and generally designated as 700. In this paper shredding tool 700, pairs of cutting blades 706, 608 are positioned along a pair of spindles, of which only one spindle 704 is shown in FIG. 19, such that the cutting planes between adjacent cutting blades 706, 708 are separated by a distance of W₉. Downstream of the movement of a piece of paper to be cut in the direction indicated by the arrow G in FIG. 19 relative to the cutting blades 706, 708, pairs of cutting blades 710, 712 are positioned along a pair of spindles, of which only one spindle 714 is shown in FIG. 19, such that the cutting planes between adjacent cutting blades 710, 712 are separated by a distance of W₁₀, which is smaller than W₉. By way of such an arrangement, it is also possible to cut out strips or pieces of paper of different widths, namely W₉ and W₁₀.

A paper shredding tool according to an eighth preferred embodiment of the present invention is shown in FIG. 20, and generally designated as 800. A major difference between this paper shredding tool 800 and the paper shredding tool 700 discussed above is that cutting blades 802, 804 for cutting narrower strips or pieces of paper is upstream of the movement of a piece of paper to be cut relative to cutting blades 806, 808 for cutting broader strips or pieces of paper.

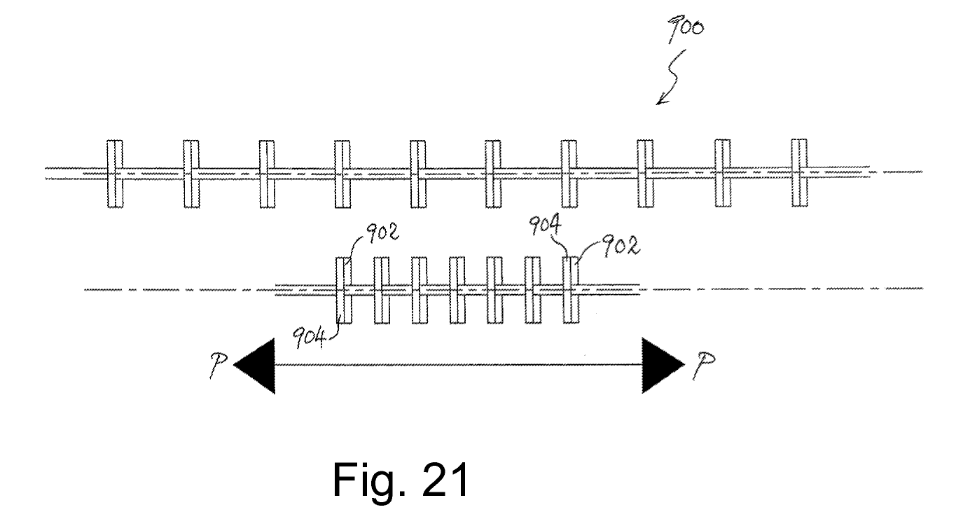

A paper shredding tool according to a ninth preferred embodiment of the present invention is shown in FIG. 21, and generally designated as 900. A major difference between this paper shredding tool 900 and the paper shredding tool 700 discussed above is that cutting blades 902, 904 for cutting narrower strips or pieces of paper are movable to and fro in the directions of the bi-directional arrow P-P, which is parallel to spindles (of which only one spindle 906 is shown in FIG. 21) carrying the cutting blades 902, 904.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A paper shredding tool including:
a first pair of cutting members partly abutting each other along a first cutting plane; a second pair of cutting members adjacent to said first pair of cutting members, said second pair of cutting members partly abutting each other along a second cutting plane;
a third pair of cutting members partly abutting each other along a third cutting plane; and
a fourth pair of cutting members adjacent to said third pair of cutting members, said fourth pair of cutting members partly abutting each other along a fourth cutting plane;
wherein each pair of cutting members are rotatable relative to each other to cut a piece of paper passing between said pair of cutting members along said respective cutting plane; and
wherein the distance between said first cutting plane and said second cutting plane is different from the distance between said third cutting plane and said fourth cutting plane.

2. A paper shredding tool according to claim 1 wherein a first cutting member of each said pair of cutting members is engaged with a first spindle for simultaneous rotational movement about said first spindle in a first direction, and a second cutting member of each said pair of cutting members is engaged with a second parallel spindle for simultaneous rotational movement about said second spindle in a second direction which is opposite to said first direction.

3. A paper shredding tool according to claim 1 wherein at least two adjacent pairs of cutting members include cutting elements protruding from their circumferences for cutting said paper along a line perpendicular to said cutting planes.

4. A paper shredding tool according to claim 1 wherein said third pair of cutting members and said fourth pair of cutting members are movable along said first and second spindles to vary their respective distance from said first pair of cutting members.

5. A paper shredding tool according to claim 4 wherein said third and fourth pairs of cutting members are engaged for simultaneous movement along said first and second spindles.

6. A paper shredding tool according to claim 5 wherein said third and fourth pairs of cutting members are reciprocalable to and from said first pair of cutting members at a substantially constant speed.

7. A paper shredding tool according to claim 5 wherein said third and fourth pairs of cutting members are reciprocable to and from said first pair of cutting members at a varying speed.

8. A paper shredding tool according to claim 5 wherein said third pair of cutting members are carried by at least one frame member for simultaneous movement.

9. A paper shredding tool according to claim 5 wherein said fourth pair of cutting members are carried by at least one frame member for simultaneous movement.

10. A paper shredding tool according to claim 1 further including
a plurality of pairs of cutting members partly abutting each other along a respective cutting plane which are away from the cutting plane of an adjacent pair of cutting members by a first distance; and
a plurality of pairs of cutting members partly abutting each other along a respective cutting plane which are away from the cutting plane of an adjacent pair of cutting members by a second distance, which is different from said first distance.

11. A paper shredding tool according to claim 1 wherein a first cutting member of each of said first and second pairs of cutting blades is engaged with a first spindle for simultaneous rotational movement about said first spindle, a second cutting member of each of said first and second pairs of cutting members is engaged with a second parallel spindle for simultaneous rotational movement about said second spindle, a first cutting member of each of said third and fourth pairs of cutting members is engaged with a third parallel spindle for simultaneous rotational movement about said third spindle, and a second cutting member of each of said third and fourth pairs of cutting members is engaged with a fourth parallel spindle for simultaneous rotational movement about said fourth spindle.

12. A paper shredding tool according to claim 11 wherein said first and second spindles are upstream of the movement of said paper through said tool and said third and fourth spindles are downstream of the movement of said paper through said tool.

13. A paper shredding tool according to claim 11 wherein said third and fourth pairs of cutting members are reciprocable along said third and fourth spindles.

14. A paper shredder including a paper shredding tool according to claim 1.
